(19) United States
(12) Patent Application Publication
(10) Pub. No.: US 2019/0210834 A1
(43) Pub. Date: Jul. 11, 2019

(54) DOOR RAIL MONITORING

(71) Applicant: Nippon Otis Elevator Company, Tokyo (JP)

(72) Inventors: Shingo Matsuki, Takatsu-ku (JP); Seietsu Wada, Takatsu-ku (JP); Kazuyoshi Yoshida, Takatsu-ku (JP); Tatsuya Sukimoto, Takatsu-ku (JP); Takahiro Kakigi, Takatsu-ku (JP); Kengo Kochi, Takatsu-ku (JP)

(21) Appl. No.: 15/866,905

(22) Filed: Jan. 10, 2018

(51) Int. Cl. B66B 5/00; B66B 13/30; B66B 13/14; B66B 13/06

(52) U.S. Cl. CPC B66B 5/0025; B66B 13/30; B66B 7/1292; B66B 13/06; B66B 13/146

(57) ABSTRACT

According to one embodiment, a method for monitoring a door rail of an elevator system is provided which comprises operating the elevator system to at least partially open a door, and to close the door at a slow speed, detecting that a door switch is closed and sending a signal when the time it takes for the door switch to close is over a predetermined value. The method for monitoring may be periodically commanded by an elevator control system.

### BACKGROUND

This invention generally relates to an elevator system. More particularly, this invention relates to monitoring a door rail of an elevator system.

In a typical elevator system, a vertically moving elevator car is positioned so as to align its entrance with corresponding openings at a plurality of landings in a multi-floor building. Modern systems typically have one or more horizontally sliding doors disposed on the elevator car and one or more horizontally sliding doors disposed at each of the landing openings, all of which remain closed during vertical movement of the elevator car.

Upon arrival of the elevator car at a floor or landing to be serviced, a door opening mechanism is activated which drives the elevator car doors horizontally for permitting access to the elevator car. In typical systems, one or more vanes, projecting from the elevator car door in the direction of an adjacent hoistway door, engage various structures, such as vanes, rollers or other protrusions projecting from the hoistway door, for driving the hoistway door horizontally together with the elevator car door, thereby permitting passengers to traverse between the car and the serviced landing.

The hoistway doors are required to remain fastened securely against unauthorized entry unless an elevator car is positioned at the landing. Various mechanisms and systems have been proposed in the prior art to secure and unsecure hoistway doors when the elevator car leaves or stops at each landing.

One such mechanism is an interlock mechanism which has a very small clearance. When dust or dirt collects on a door rail which guides a hoistway door, the dust or dirt will eventually accumulate at the end of travel of the hoistway door. This may narrow the clearance and the hoistway door may be prevented from closing or opening.

In most situations, a mechanic periodically inspects the door rail during maintenance by opening the hoistway door and visually inspecting the closing of the hoistway door at each floor. The mechanic cleans the door rail if there seems to be an abnormal condition. Such inspection is time consuming and it is a matter of concern when it is necessary to inspect such condition in a high-rise building including a multiple of floors.

In view of the above and other considerations, there is a need for inspecting hoistway door rails of an elevator system in a more efficient manner.

### BRIEF SUMMARY

According to one embodiment, a method for monitoring a door rail of an elevator system is provided which comprises operating the elevator system to at least partially open a door, and to close the door at a slow speed, detecting that a door switch is closed and sending a signal when the time it takes for the door switch to close is over a predetermined value.

In addition to one or more of the features described above, or as an alternative, further embodiments may be included wherein the method for monitoring is periodically commanded by an elevator control system.

In addition to one or more of the features described above, or as an alternative, further embodiments may be included wherein the method for monitoring is commanded from a central control room.

In addition to one or more of the features described above, or as an alternative, further embodiments may be included wherein the method for monitoring is commanded via an application installed on a mobile device.

In addition to one or more of the features described above, or as an alternative, further embodiments may be included wherein the method for monitoring is performed in a maintenance mode of operation.

In addition to one or more of the features described above, or as an alternative, further embodiments may be included wherein the method for monitoring is preformed during normal operation.

In addition to one or more of the features described above, or as an alternative, further embodiments may be included wherein said time is counted from when the door starts closing to when the closing of the door switch is detected.

In addition to one or more of the features described above, or as an alternative, further embodiments may be included wherein said predetermined value is set so that a certain degree of accumulation of dust or dirt on the door rail will be detected.

In addition to one or more of the features described above, or as an alternative, further embodiments may be included wherein operating the elevator system includes partially opening the door to a predetermined position and closing the door at a speed slower than normal operation.

In addition to one or more of the features described above, or as an alternative, further embodiments may be included wherein operating the elevator system is based on elevator door position signals from a pulley encoder.

In addition to one or more of the features described above, or as an alternative, further embodiments may be included wherein sending a signal includes sending a signal to a central control room via an elevator control system.

In addition to one or more of the features described above, or as an alternative, further embodiments may be included wherein the door rail is a hoistway door rail.

In addition to one or more of the features described above, or as an alternative, further embodiments may be included wherein the hoistway door rail is sequentially inspected at each floor.

In addition to one or more of the features described above, or as an alternative, further embodiments may be included wherein the signal includes the floor at which said time is over a predetermined value and the number of the elevator.

In addition to one or more of the features described above, or as an alternative, further embodiments may be included wherein the elevator system comprises an interlock mechanism which includes an interlock lever provided to rotate about a rotational axis and a stationary keeper.

In addition to one or more of the features described above, or as an alternative, further embodiments may be included wherein a small clearance is provided between the interlock lever and the stationary keeper and the clearance is narrowed when dust or dirt collects on the hoistway door rail.

In addition to one or more of the features described above, or as an alternative, further embodiments may be included wherein the interlock lever includes a contact for the door switch.

In addition to one or more of the features described above, or as an alternative, further embodiments may be included wherein the door rail is a car door rail.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the disclosure are apparent from the following detailed description taken in conjunction with the accompanying drawings in which like elements are numbered alike in the several Figs.

FIG. 1 illustrates a schematic view of an exemplary interlock mechanism of an elevator system.

FIG. 2 illustrates a block diagram of an exemplary elevator control system.

FIG. 3 illustrates a flow chart of a method of monitoring a hoistway door rail according to the present invention.

### DETAILED DESCRIPTION

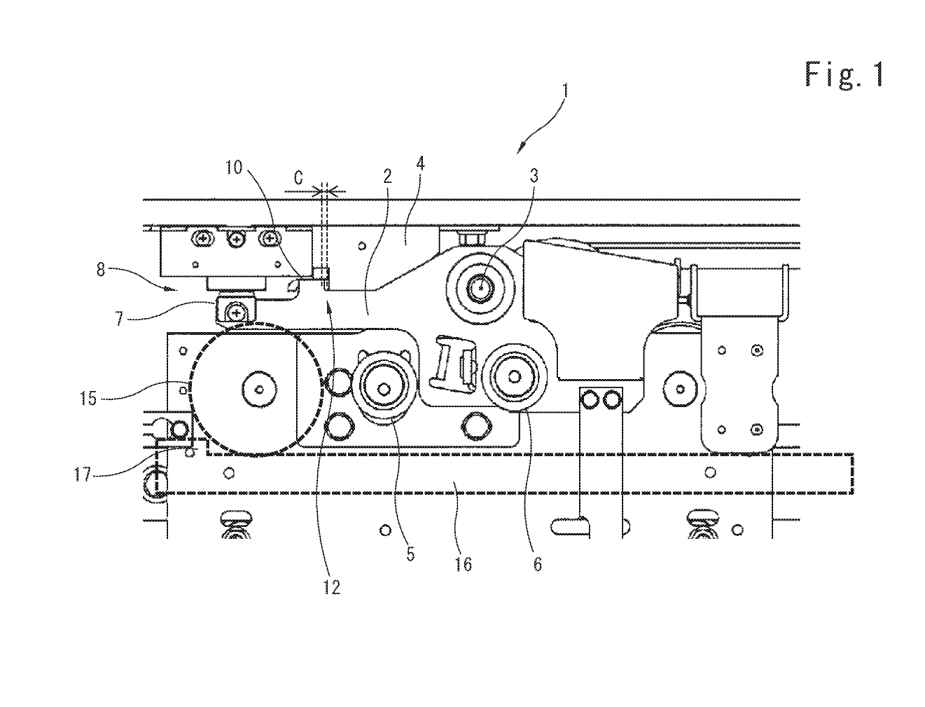

FIG. 1 schematically illustrates an exemplary interlock mechanism 1. The interlock mechanism 1 includes an interlock lever 2 provided to rotate about a rotational axis 3, a stationary keeper 4, a first roller 5 and a second roller 6. The interlock lever 2 includes a contact 7 for a door switch 8 and a tab 10 which together with the keeper 4 forms a latch 12. The first roller 5 rotates about a fixed axis and the second roller 6 is attached to the interlock lever 2.

As shown in FIG. 1, when there is no elevator car at the landing, the interlock lever 2 is biased by a spring (not shown) in a clock-wise direction such that the latch 12 is engaged and the door switch 8 is closed. In this condition, a hoistway door which may include one or a plurality of door panels is fastened securely against unauthorized entry and the elevator car may move vertically through a hoistway.

Upon arrival of an elevator car at the landing, a vane projecting from an elevator car door in the direction of the hoistway door pushes the second roller 6 to the right such that the interlock lever 2 rotates in the counterclockwise direction. This causes disengagement of the latch 12 and opening of the elevator switch 8. In this condition, the hoistway door may move horizontally together with the elevator car door as the elevator car door is driven via a door opening mechanism for permitting access to the elevator car. Since the elevator switch 8 is open, the elevator car is prevented from vertically moving through the hoistway.

In the latched condition of the interlock mechanism 1 as shown in FIG. 1, a clearance C is provided between the tab 10 of the interlock lever 2 and the keeper 4. This clearance C is set to be very small, for example, about two millimeters.

A hoistway door panel (not shown) is attached to a hanger roller 15 guided along a door rail 16. The hanger roller 15 is guided along the door rail 16 between an open position of the hoistway door and a closed position of the hoistway door. In the closed position, the movement of the hanger roller 15 is limited by a stopper 17.

When dust or dirt collects on the door rail 16, it will eventually accumulate at the end of travel of the hanger roller 15, i.e., between the hanger roller 15 and the stopper 17. This may cause a delay of the time it will take for the hanger roller 15 to reach the end of travel, i.e., the time it will take for engagement of the latch 12 and for closing of the door switch 8. Further, the clearance C between the tab 10 of the interlock lever 2 and the keeper 4 will gradually be narrowed. This may cause the tab 10 and the keeper 2 to finally interfere with each other and prevent the hoistway door from closing or opening.

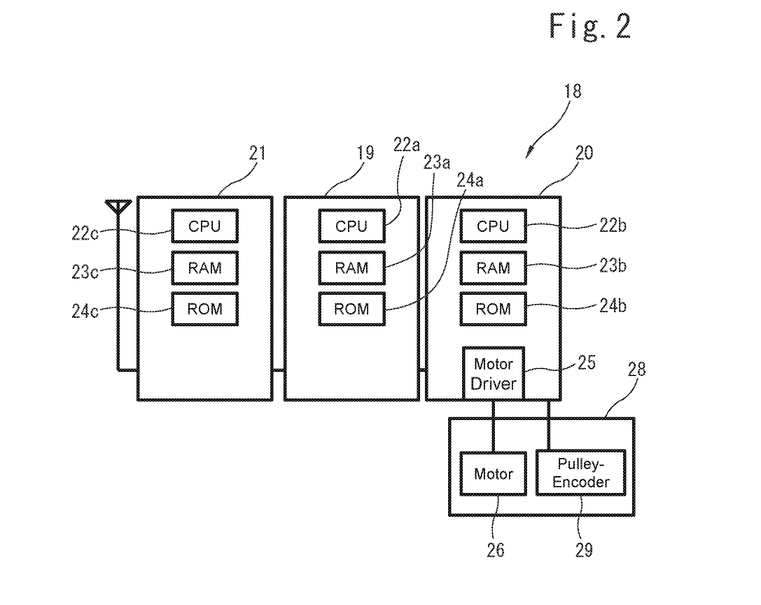

FIG. 2 shows a block diagram of an exemplary elevator control system 18. The elevator control system 18 comprises a main controller 19 respectively connected to a door controller 20 and a Remote Elevator Monitoring/Remote Elevator Inspecting (REM/REI) system 21. The main controller 19, door controller 20 and REM/REI system 21 each comprises a Central Processing Unit (CPU) 22, Random-Access Memory) RAM 23 and Read-Only Memory (ROM) 24. The door controller 20 further comprises a motor driver 25 for controlling a motor 26 for driving the elevator car door 28. The door controller 20 receives elevator door position signals from a pulley encoder 29. The REM/REI system 21 may be configured to transmit signals to a central control room by wired or wireless communication.

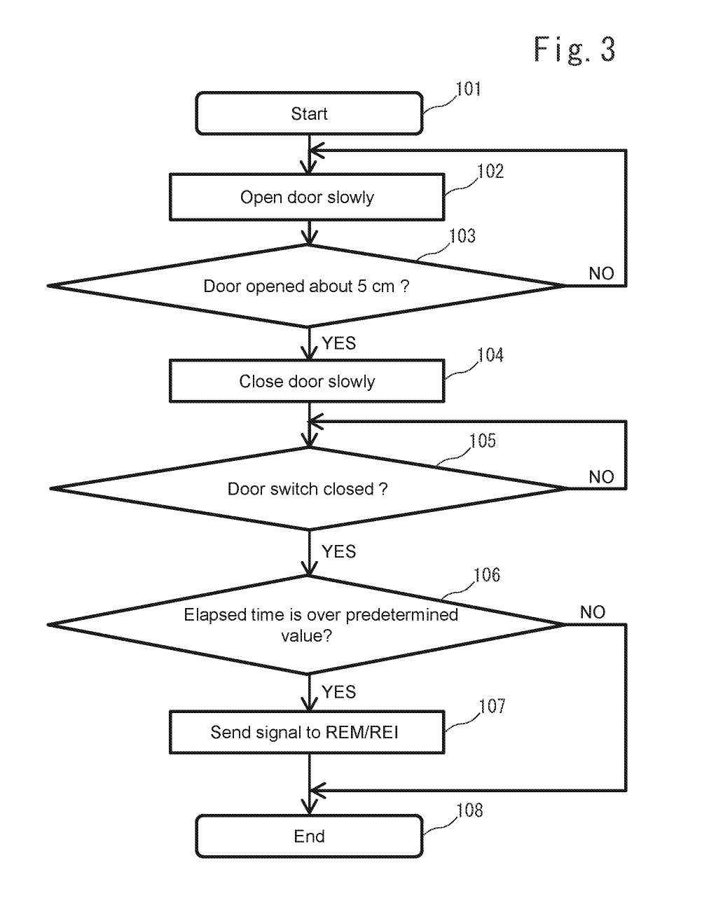

FIG. 3 shows a flow chart of a method of monitoring a hoistway door rail of the present invention. Monitoring is started in step 101. First, the hoistway door is opened at a first speed slower than a normal operating speed (step 102). In step 103, it is checked if the door is opened about five centimeters. This may be determined based on elevator door position signals received from the pulley encoder 29. If NO, the program returns to step 102 and the door is continuously opened. If YES, the program proceeds to step 104 and the door is closed at a second speed slower than the first speed.

In step 105, it is checked if the door switch 8 is closed. If NO, step 105 is repeated. If YES, it is checked in step 106 if the elapsed time, from when the door starts closing to the closing of the door switch 8, is over a predetermined value. The elapsed time may be counted by a timer. If NO, the program proceeds to step 108 and the monitoring ends. If YES, a signal is sent to the REM/REI system 21 to notify the system that inspection of the door rail 16 is necessary. The signal may include the floor and/or the number of the elevator car at which the elapsed time is over a predetermined value. The signal may be communicated from the REM/REI system 21 to the central control room by wired or wireless communication.

The method of the present invention is based on the fact that the time it takes for the hoistway door to reach its closed position will increase when dust or dirt collects on the door rail 16 and accumulates at the end of travel of the hanger roller 15. This phenomenon is monitored by the time it takes for the door switch 8 to be closed. The slow closing speed of the hoistway door, in particular, allows detection of accumulation of dust or dirt on the door rail 16. Such accumulation is detected before the interlock lever 2 and keeper 4 interfere with each other.

Monitoring may be performed in a maintenance mode of operation. The elevator car may be operated to run to the uppermost landing or to the lowermost landing and the hoistway door rail may be sequentially inspected at each floor. Each time it is detected that the elapsed time is over a predetermined value, a signal is sent to the REM/REI system 21. The predetermined value may be set so that a certain degree of accumulation of dust or dirt on the door rail 16 will be detected.

Monitoring may also be performed during normal operation. In this case, the hoistway door rails will be randomly monitored as the elevator car stops at floors requested by passengers.

Monitoring may be periodically commanded by the main controller 19 and carried out either by the main controller 19 or door controller 20. It is also possible to command monitoring from the central control room. Alternatively or additionally, a mechanic may start monitoring at the site via an application installed on a smart phone, cell phone, tablet, lap top computer or any other mobile device.

As described above, according to the present invention, monitoring of hoistway door rails may be carried out automatically by the elevator control system. When a certain degree of dust or dirt is detected, a signal is sent via the REM/REI system 21 to the central control room to notify that inspection of the door rail 16 is necessary. This will allow a mechanic to inspect and clean the specific hoistway door rail before dust or dirt accumulates on the hoistway door rail to a serious degree which may prevent the hoistway door from closing or opening.

The mechanic will only have to inspect hoistway door rails 16 which are detected to have a certain degree of dust or dirt. In this way, it will be possible to inspect hoistway door rails 16 in a more efficient manner. This will be particularly effective in high-rise buildings including a considerable number of hoistway door rails.

Although the present invention has been described with respect to a hoistway door rail, it can equally be used to monitor a car door rail for guiding an elevator car door.

The terminology used herein is for the purpose of describing particular embodiments only and is not intended to be limiting. While the description has been presented for purposes of illustration and description, it is not intended to be exhaustive or limited to embodiments in the form disclosed. Many modifications, variations, alterations, substitutions or equivalent arrangement not hereto described will be apparent to those of ordinary skill in the art without departing from the scope of the disclosure. Additionally, while the various embodiments have been described, it is to be understood that aspects may include only some of the described embodiments. Accordingly, the disclosure is not to be seen as limited by the foregoing description, but is only limited by the scope of the appended claims.

What is claimed is:

1. A method for monitoring a door rail of an elevator system, comprising:
operating the elevator system to at least partially open a door, and to close the door at a slow speed;
detecting that a door switch is closed; and
sending a signal when the time it takes for the door switch to close is over a predetermined value.

2. The method of claim 1, wherein the method for monitoring is periodically commanded by an elevator control system.

3. The method of claim 1, wherein the method for monitoring is commanded from a central control room.

4. The method of claim 1, wherein the method for monitoring is commanded via an application installed on a mobile device.

5. The method of claim 1, wherein the method for monitoring is performed in a maintenance mode of operation.

6. The method of claim 1, wherein the method for monitoring is preformed during normal operation.

7. The method of claim 1, wherein said time is counted from when the door starts closing to when the closing of the door switch is detected.

8. The method of claim 1, wherein said predetermined value is set so that a certain degree of accumulation of dust or dirt on the door rail will be detected.

9. The method of claim 1, wherein operating the elevator system includes partially opening the door to a predetermined position and closing the door at a speed slower than normal operation.

10. The method of claim 9, wherein operating the elevator system is based on elevator door position signals from a pulley encoder.

11. The method of claim 1, wherein sending a signal includes sending a signal to a central control room via an elevator control system.

12. The method of claim 1, wherein the door rail is a hoistway door rail.

13. The method of claim 12, wherein the hoistway door rail is sequentially inspected at each floor.

14. The method of claim 12, wherein the signal includes the floor at which said time is over a predetermined value and the number of the elevator.

15. The method of claim 12, wherein the elevator system comprises an interlock mechanism which includes an interlock lever provided to rotate about a rotational axis and a stationary keeper.

16. The method of claim 15, wherein a small clearance is provided between the interlock lever and the stationary keeper and the clearance is narrowed when dust or dirt collects on the hoistway door rail.

17. The method of claim 15, wherein the interlock lever includes a contact for the door switch.

18. The method of claim 1, wherein the door rail is a car door rail.
